(19) United States
(12) Patent Application Publication
(10) Pub. No.: US 2014/0114820 A1
(43) Pub. Date: Apr. 24, 2014

(54) METHOD AND SYSTEM FOR MANAGING CREDIT DISPUTES ASSOCIATED WITH ACCOUNT PAYABLES OF AN ORGANIZATION

(71) Applicant: Manoj Kumar, North Brunswick, NJ (US)

(72) Inventor: Manoj Kumar, North Brunswick, NJ (US)

(73) Assignee: IPAYDEX INC., NewPort Beach, CA (US)

(21) Appl. No.: 14/058,826

(22) Filed: Oct. 21, 2013

Related U.S. Application Data
(60) Provisional application No. 61/715,999, filed on Oct. 19, 2012.

(51) Int. Cl. G06Q 40/00

(52) U.S. Cl. CPC G06Q 40/10
USPC 705/30

(57) ABSTRACT

The various embodiments herein provide a method and system for managing credit disputes associated with account payables of an organization. The method comprises of fetching a current version of a variance data from a database, determining whether the variance data matches with a pre-recorded data, creating a claim for a discrepancy in the variance data if the variance data does not match with the pre-recorded data and generating one or more notifications based on the discrepancy. The variance data comprises at least one of purchase order information, invoice information; items received information and payment information. Once the claim has been created the credit that comes back is match to wring every single penny.

### CROSS-REFERENCE TO RELATED APPLICATION

This application claims priority of the U.S. Provisional Application No. 61/715,999, filed Oct. 19, 2012, which is incorporated herein by reference in its entirety.

### FIELD OF TECHNOLOGY

The present disclosure generally relates to dispute resolution of credit data, and more particularly relates to a method and system for managing credit disputes associated with account payables of an organization.

### BACKGROUND

Growth of an organization lies in proper maintenance of the organization's financial transactions. The financial transactions of the organization generally include accounts payable and accounts receivable. In larger organizations, a separate department is set up to manage these financial transactions. The term “accounts payable” refers to the liabilities to be paid by the organization for the purchase of goods or services received from a supplier or a vendor.

An accounts payable function includes tasks of processing invoices, matching invoices with purchase orders and receipts, approving invoices for payment, managing terms, paying invoices based on the terms, applying credits, and confirming payment of invoices. In addition to process invoices and proper application of the payments, write-offs and appropriate reporting capabilities needs to be managed skillfully. These tasks are time-consuming and often take away resources of the corporation from its operations and other profitable activities.

Generally a supplier raises an invoice for supplying goods and services. This invoice is matched against the purchase order (PO) and subsequent goods received (GR). During the 3 way match, if there is a discrepancy between the PO Unit Price and the Invoice unit price or the Invoice quantity (QTY) and the GR QTY, a claim is created to recover money from the supplier. This ensures the organization pays for what it needed to. The credit given by the supplier is needed to be matched with the claim created. However, in an accounts payable process, unmanaged claim creation to credit reconciliation may result in loss of cash flow to the organization. Examples of unmanaged claim creation may include supplier companies invoicing for items they didn't provide, double Invoicing, Invoices with difference in quantity of items, Invoices with different Unit price than the PO, applying bulk credits and other misunderstandings.

When such dispute arises, the buyers may delay payment of invoices while the supplier may investigate reasons for the dispute. It requires involvement of a huge work force to manually resolve credit disputes and recover the disputed credit. Eventually, the buyers may miss out on collecting millions of dollars of potential credits each year. Therefore, it becomes cumbersome and tedious task to clear out huge volume of invoices while ensuring that disputes arising out of the huge volume of invoices are resolved without delay in the payment. Currently, Enterprise Resource Planning (ERP) solutions fail to provide functionality for resolving disputes in the credit and recovering the disputed credit.

In view of the foregoing, there is a need for an automated method and system that is capable of facilitating credit and disputes related to account payables of an organization.

The above mentioned shortcomings, disadvantages and problems are addressed herein and which will be understood by reading and studying the following specification.

### SUMMARY

The primary objective of the embodiments herein is to provide a method and system for managing credit and dispute for accounts payable process of an organization.

Another objective of the embodiments herein is provide a method and system for identifying discrepancy between purchase orders, Invoice and the goods received (GR).

Another objective of the embodiments herein is to provide a method and system for providing a three way visual representation of the discrepancy between the blocked invoices, purchase orders and items received.

Another objective of the embodiments herein is to provide a method and system for automatically creating claims and generating notifications for deductions based on the discrepancy.

The various embodiments herein provide a method for managing credit disputes corresponding to account payables of an organization. The method comprising the steps of fetching a current version of a variance data from a database, determining whether the variance data matches with a pre-recorded data, creating a claim for a discrepancy in the variance data if the variance data does not match with the pre-recorded data and generating one or more notifications based on the discrepancy. The variance data herein comprises at least one of purchase order information, invoice information, items received information and payment information.

According to an embodiment herein, determining whether the variance data matches with a pre-recorded data comprises of reading a plurality of records associated with the variance data stored in the database, verifying if the received information associated with the record is same as compared to the pre-recorded data if the record already exists in the database, verifying if a credit received is more than a predetermined value, auto-accepting the credit if the credit received is more than the predetermined value; and performing a pre-defined action associated with the auto accepted credit.

According to an embodiment herein, the predefined action comprises at least one of payback the previous claim created for an invoice data, posting the credit and posting a write off

According to an embodiment herein, the method further comprises creating a reduction claim for a remaining credit by matching the credit to the claim if the received credit is less than the pre-determined value.

According to an embodiment herein, the method further comprises marking the record for payback of a previous claim if the received information associated with the record and the pre-recorded data are same.

In another aspect herein, the method comprises of determining one or more auto deduction codes if the record for the variance data is new and enabling creation of a new claim based the new record.

According to an embodiment herein, the notifications comprise at least one of sending intimation for deductions and information for posting claims.

Embodiments herein further provide a system for managing credit disputes corresponding to account payables of an organization. The system comprises an Enterprise Resource Planning (ERP) module associated with a business enterprise device, a server associated with the business enterprise module connected to the business enterprise device, a database adapted for storing a plurality of variance data and a credit dispute management (CDM) module. The CDM module herein is adapted for fetching a current version of a variance data from the database, determining whether the variance data matches with a pre-recorded data, creating a claim for a discrepancy in the variance data if the variance data does not match with the pre-recorded data and generating one or more notifications based on the discrepancy.

According to an embodiment herein, the system further comprises an output module configured for displaying one or more notifications generated based on the discrepancy, where the notifications comprises sending intimation for deductions and information for posting claims.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 is a block diagram illustrating an exemplary system for managing credit disputes for account payables for an organization, according to an embodiment herein.

FIG. 2 is a flow chart illustrating an exemplary method of managing credit disputes corresponding to account payables of an organization, according to an embodiment herein.

FIG. 3 is a flow chart illustrating an exemplary method of managing credit in an account payable process of an organization, according to an embodiment herein.

FIG. 4 is a flow chart illustrating an exemplary method of automatically creating a claim for a record, according to an embodiment herein.

FIG. 5 illustrates a block diagram of an exemplary computing environment in which any of the embodiments disclosed herein may be performed.

FIG. 6 is an illustrative diagram showing a screen displaying an exemplary database for managing account payables of an organization, according to an embodiment herein.

Although specific features of the present invention are shown in some drawings and not in others. This is done for convenience only as each feature may be combined with any or all of the other features in accordance with the present invention.

### DETAILED DESCRIPTION OF THE EMBODIMENTS

The present invention provides a method and system for managing variance data and disputes associated with account payables of an organization. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

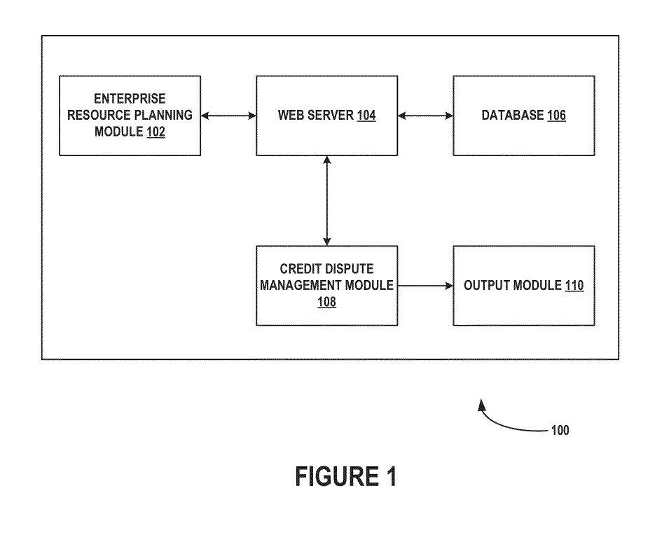

FIG. 1 is a block diagram illustrating an exemplary system for managing credit disputes for account payables for an organization, according to an embodiment herein. As shown in FIG. 1, the system comprises of an Enterprise Resource Planning (ERP) module 102, a web server 104, a database 106, a credit dispute management (CDM) module 108 and an output module 110. The CDM module 108 interacts with the ERP module 102 and the database 108 using the web server 104.

The ERP module 102 is a business management application that allows an organization to use a system of integrated applications to manage accounts payable process of the organization. The database 106 is a repository for storing cross tabulated variance Information on the purchase orders(PO), invoice and goods received (GR) from the ERP module and claims the credits generated through an electronic means (e.g., email, web portal, fax, Electronic Data Interchange (EDI), etc.). The CDM module 108 is configured for managing credits and disputes arising out of the invoices. For example, the CDM module 108 is adapted for fetching the variance data from the database 106, where the variance data comprises blocked invoices, purchase orders and the goods received. The CDM module 108 identifies discrepancy between the purchase orders invoices and goods received (GR), and provide a three way visual representation of discrepancy between the three sources of information. Further, the CDM module 108 automatically creates claims based on the discrepancy identified in the variance data and generates notifications for deductions accordingly. The output module 110 is configured for displaying the claims created for the discrepancies, notifications for the deductions, posting write offs and the like.

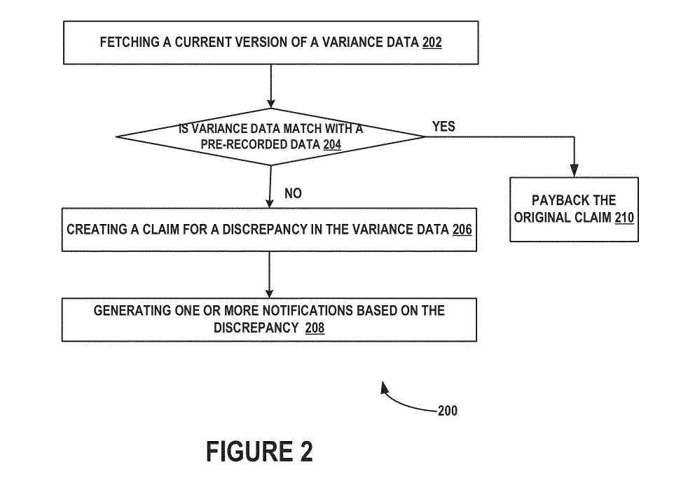

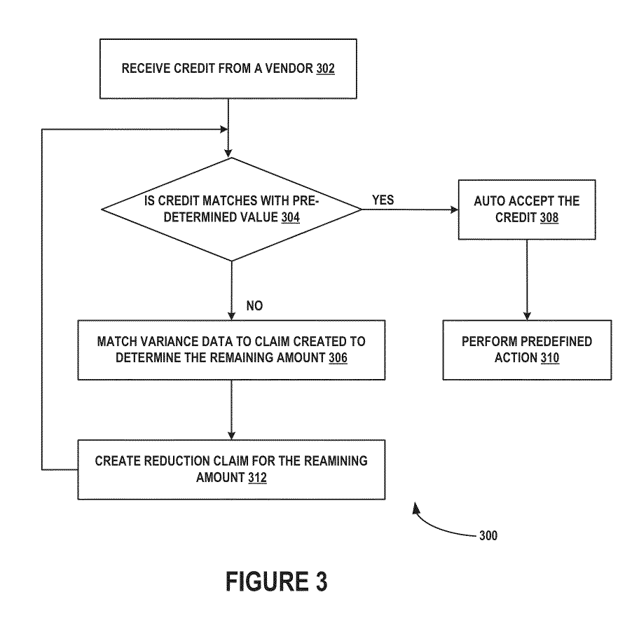

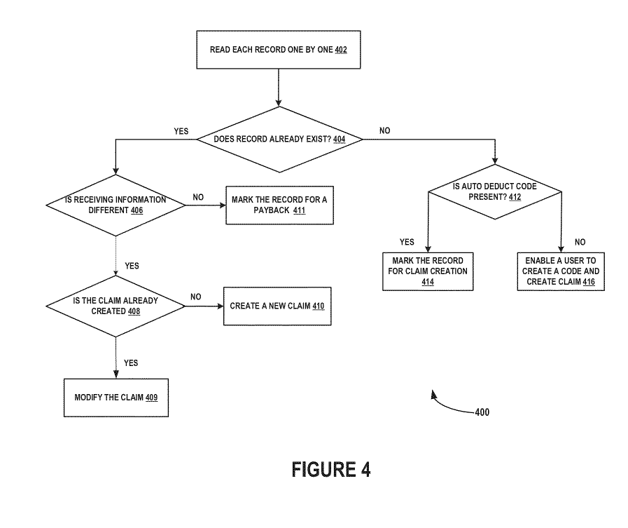

FIG. 2 is a flow chart illustrating an exemplary method of managing credit disputes corresponding to account payables of an organization, according to an embodiment herein. At step 202, a current version of a variance data is fetched from a database by a credit dispute management module. The variance data comprises at least one of a purchase order information, invoice information, items received information and payment information. At step 204, the CDM performs a check to determine whether the variance data matches with a pre-recorded data. The pre-recorded data comprises information regarding purchase order and invoice that is initially agreed between two parties such as a seller and a vendor. If the variance data matches with the pre-recorded data, then at step 210, a predefined action such as paying back the original claim is performed. At step 206, the CDM creates a claim for a discrepancy identified in the variance data if the variance data does not match with the pre-recorded data. The discrepancy may be due to a mismatch in the credit value mentioned in variance data and the pre-recorded variance data, mismatch in purchase order and the items received, duplicate invoicing, etc. In view of the same, the embodiments herein generate a three way visual representation of discrepancy between three sources of information. Later on at step 208, one or more notifications for the mismatched variance data are generated based on the discrepancy. The one or more notifications may comprise at least one of sending intimation for deductions and information for posting claims. The process of managing the credits disputes associated with account payables is described in greater detail in the description of FIGS. 3 and 4.

FIG. 3 is a flow chart illustrating an exemplary method of managing credit in an account payable process of an organization, according to an embodiment herein. At step 302, a credit is received by the credit dispute management module. The term credit refers to a bill or invoice received from a vendor company that contains information regarding money, purchase order, goods received, etc., for the purchase of goods and services obtained from the vendor company. At step 304, a check is performed to determine whether the credit received is matches with a pre-determined value. The pre-determined value refers to actual invoice to be raised for the purchase of goods and services obtained from the vendor company. If the credit received matches with the predetermined value, then at step 308, the credit is automatically accepted by the CDM module 108. Once the credit is automatically accepted, at step 310, predefined actions such as payback original claim, post credit, and post write off, etc., is performed.

If the credit received does not match with the pre-determined value, then at step 306, remaining amount/goods to be received is determined by matching the variance data to the claim created initially. Further, at step 312, a reduction claim is created by the system for the remaining amount/goods and the process is routed again to step 302. The process steps 302 to 310 are repeated until the desired credit has been received from the vendor.

For example, consider that a company X purchases 1000 units from a vendor company. Consider a sum of Rs 1 lakh is to be paid by the company X to the vendor company. The credit dispute management system in company X generates a claim for the above mentioned details. Consider that the vendor company supplies only 500 units and raised the invoice for 1000 units. The credit dispute management system receives the invoice from the vendor company in return of supplying the 500 units. The invoice can be received from any electronic processing means. As shown in FIG. 3, the credit dispute management system checks the invoice received from the vendor company against the pre-determined value. After checking, the credit dispute management system identifies a discrepancy in the credit received by matching the purchase order, invoice information in the credit received data with the claim created. The credit dispute management system creates a reduction claim for the remaining 500 units.

FIG. 4 is a flow chart illustrating an exemplary method of automatically creating a claim for a record, according to an embodiment herein. At step 402, each record stored in the database is read by the module after receiving a variance data. The variance data comprises information regarding purchase order, invoice, invoice number, line number etc. At step 404, it is determined whether a record for the variance data already exists in the database. If the variance data is already there, then at step 406, it is further determined whether the receiving information in the variance data associated with the record is same as compared with a pre-recorded data. If the receiving information is different, then at step 408, it is determined whether a claim is already created. If not, a new claim is created for the record at step 410. If the claim is already created then at step 409, the claim is modified according to the receiving information.

If the receiving information is same, then at step 411, the CDM module marks the record for payback for the previous claim. If the record does not exist in the database, then at step 412, it is determined whether an auto deduct code is present for the record. The auto deduct code is generally used by the system to identify a record. If the auto deduct code is present, at step 414, the record is marked for claim creation. If the auto deduct code is not present, then at step 416, the CDM module enables a user to create a code for the record and creates the claim accordingly.

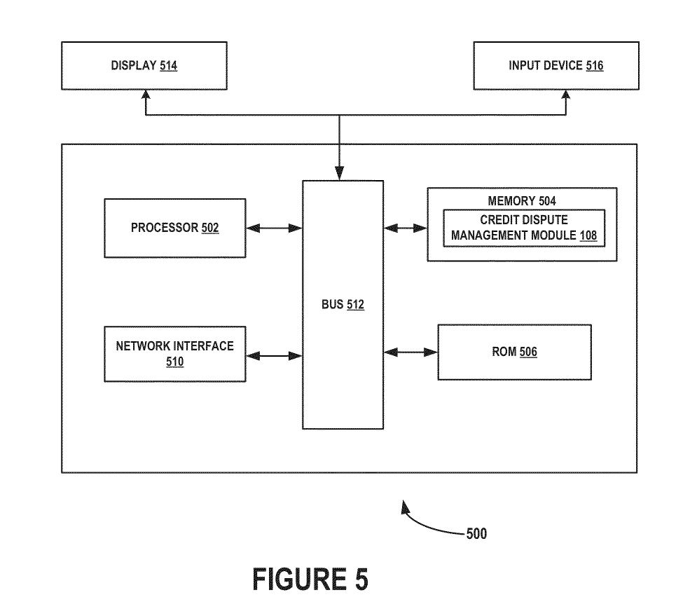

FIG. 5 illustrates a block diagram of an exemplary computing environment 500 in which any of the embodiments disclosed herein may be performed. The computing environment 500 herein includes a processor 502, memory 504, a read only memory 506, a display 514 and an input device 516. The computing environment 500 additionally includes a bus 512 and a network interface 510. The computing environment unit 500 may include or have access to one or more user input devices 516, and one or more communication connections 510 such as a network interface card or a universal serial bus connection. The one or more user input devices 516 may be a computer, PDA etc. The one or more output devices 514 may be a display screen of the computing environment 500. The communication connections 510 may include a wireless communication network such as wireless area network, local area network, Global System for Mobile communications (GSM), Enhanced Data rates for GSM Evolution (EDGE), General Packet Radio Service (GRPS) and the like.

The memory 504 may include volatile memory and non-volatile memory. A variety of computer-readable storage media may be stored in and accessed from the memory elements of the computing environment 500, the read only memory 506. Computer memory elements may include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, Memory Sticks™, and the like. The memory further includes a credit dispute management (CDM) module 108 which is adapted to manage credit disputes associated with account payables of an organization. The CDM module 108 fetches a current version of a variance data from a database and determines whether the variance data matches with a pre-recorded data. The CDM module 108 also creates claim for discrepancies in the variance data if the variance data does not match with the pre-recorded data. The CDM module 108 also generates one or more notifications based on the discrepancy.

The processor 502, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 502 may also include embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, and application programs, for performing tasks, or defining abstract data types or low-level hardware contexts. Machine-readable instructions may be stored on any of the above-mentioned storage media and may be executable by the processor 502 of the computing environment 500. For example, a computer program may include the machine-readable instructions capable of determining an incoming record is new or already existing and processing the record based on the determination, according to the teachings and herein described embodiments of the present subject matter. In one embodiment, the computer program includes the credit and dispute management module 108 for processing a credit in dispute. The computer program may be included on a compact disk-read only memory (CD-ROM) and loaded from the CD-ROM to a hard drive in the memory 504. The machine-readable instructions may cause the computing environment 500 to manage the credit and disputes of an accounts payable process of an organization, according to the various embodiments of the present subject matter.

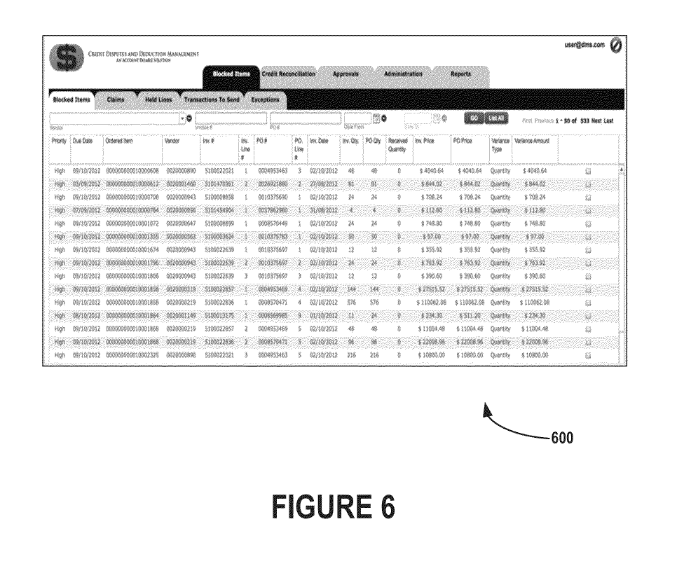

FIG. 6 illustrates a screenshot view of an exemplary database maintained in the credit dispute management system, according to one embodiment. As shown in FIG. 6, the database consists of separate tabs maintained for disputed invoice, credit reconciliation, reports etc. In one exemplary operation, a user can view the blocked items. The blocked items consists of data regarding due date to make the payment, vendor name, code created for the vendor, purchase order details, PO line number, price, variance type, variance amount etc. Thus, the database provides three way visual representation of the discrepancy between the blocked Invoices, purchase orders and the goods received to the user. The user can easily identify the variance with respect to amount/goods quantity without the need of manually checking the invoices.

According to an embodiment herein, the method and system herein provides for reducing quarterly accrual relating to vendor claims and improving cash flow in an organization. Also it reduces bad debts caused by write offs.

Although the embodiments herein are described with various specific embodiments, it will be obvious for a person skilled in the art to practice the invention with modifications. However, all such modifications are deemed to be within the scope of the claims. It is also to be understood that the following claims are intended to cover all of the generic and specific features of the embodiments described herein and all the statements of the scope of the embodiments which as a matter of language might be said to fall there between.

What is claimed is:

1. A method for managing credit disputes corresponding to account payables of an organization, the method comprising steps of:
fetching a current version of a variance data from a database;
determining whether the variance data matches with a pre-recorded data;
creating a claim for a discrepancy in the variance data if the variance data does not match with the pre-recorded data; and
generating one or more notifications based on the discrepancy.

2. The method of claim 1, wherein variance data comprises at least one of purchase order information, invoice information, items received information and payment information.

3. The method of claim 1, wherein determining whether the variance data matches with a pre-recorded data comprises of:
reading a plurality of records associated with the variance data stored in the database;
verifying if the received information associated with the record is same as compared to the pre-recorded data if the record already exists in the database;
verifying if a credit received is more than a predetermined value; and
auto-accepting the credit if the credit received is more than the predetermined value; and
performing a pre-defined action associated with the auto accepted credit.

4. The method of claim 3, wherein the predefined action comprises at least one of payback the previous claim created for an invoice data, posting the credit and posting a write off.

5. The method of claim 3, further comprising:
creating a reduction claim for a remaining credit by matching the credit to the claim if the received credit is less than the pre-determined value.

6. The method of claim 3, further comprising:
marking the record for payback of a previous claim if the received information associated with the record and the pre-recorded data are same.

7. The method of claim 3, further comprising:
determining one or more auto deduction codes if the record for the variance data is new; and
enabling creation of a new claim based the new record.

8. The method of claim 1, wherein the notifications comprises at least one of sending intimation for deductions and information for posting claims.

9. A system for managing credit disputes corresponding to account payables of an organization, the system comprising:
an Enterprise Resource Planning (ERP) module associated with a business enterprise device;
a server associated with the business enterprise module connected to the business enterprise device;
a database adapted for storing a plurality of variance data;
a credit dispute management module configured for:
fetching a current version of a variance data from the database;
determining whether the variance data matches with a pre-recorded data;
creating a claim for a discrepancy in the variance data if the variance data does not match with the pre-recorded data; and
generating one or more notifications based on the discrepancy.

10. The system of claim 9, further comprising an output module configured for displaying one or more notifications generated based on the discrepancy, where the notifications comprises sending intimation for deductions and information for posting claims.

11. The system of claim 9, wherein the CDM module comprises at least one module adapted for:
reading a plurality of records associated with the variance data stored in the database;
verifying if the received information associated with the record is same as compared to the pre-recorded data if the record already exists in the database;
verifying if a credit received is more than a predetermined value;
auto-accepting the credit if the credit received is more than the predetermined value; and
performing a pre-defined action associated with the auto accepted credit.

12. The system of claim 9, wherein the CDM is further adapted for creating a reduction claim for a remaining credit by matching the credit to the claim if the received credit is less than the pre-determined value.

13. The system of claim 9, wherein the output module is further adapted for displaying a three dimensional representation of one or more parameters of the variance data, where the parameters comprise at least one of purchase order, invoice raised and items received.
